(19) United States
(12) Patent Application Publication
(10) Pub. No.: US 2008/0073627 A1
(43) Pub. Date: Mar. 27, 2008

(54) Flame resistance natural fiber-filled thermoplastics with improved properties

(76) Inventors: Michael J. Goode, West Lafayette, IN (US); Mary Harscher, Lafayette, IN (US); William D. Sigworth, Naugatuck, CT (US); Timothy T. Lawlor, Lafayette, IN (US)

Correspondence Address: Daniel Reitenbach;CHEMTURA CORPORATION, 199 Benson Road, Middlebury, CT, 06749, US

(21) Appl. No.: 11/903,288

(22) Filed: Sep. 21, 2007

Related U.S. Application Data
(60) Provisional application No. 60/847,298, filed on Sep. 25, 2006.

(51) Int. Cl. C09K 21/06

(52) U.S. Cl. 252/607

(57) ABSTRACT

The invention relates to flame retardant systems including the brominated flame retardants and chlorinated flame retardants with synergists and char formers for use in wood-filled resins in combination with compatibilizers to enhance physical properties and to increase water extraction resistance and long term durability. Desirable embodiments of the invention relate to brominated and chlorinated flame retardant additives, synergists, and char formers for use in resins, including polyolefins, fillers, wood-filled polyolefins, in combination with compatibilizers and methods of use of the flame retardants and fillers. The invention includes methods of making and using the composition.

We claim the benefit under Title 35, United States Code, §119 of U.S. Provisional Application No. 60/847,298, filed Sep. 25, 2006, entitled “Flame Resistance Natural Fiber-Filled Thermoplastics with Improved Properties.”

### BACKGROUND OF THE INVENTION

1. Field of the Invention

The invention relates to flame retardant systems including the halogenated flame retardants with synergists and char formers for use in cellulose-filled resins in combination with compatibilizers to enhance physical properties, increase water extraction resistance, and increase long-term durability through the selection of the appropriate combination for flame retardancy performance. Specifically, the invention relates to brominated and chlorinated flame retardant additives and synergists and char formers for use in resins, including polyolefins, fillers, and wood-filled polyolefins in combination with compatibilizers and methods of use of the flame retardants and fillers.

2. Description of Related Art

Natural fiber-filled thermoplastics, particularly wood-filled polyolefins, are widely used to make articles for outdoor use. These outdoor uses include applications such as decking surfaces, railing systems, fencing, railroad ties, and landscape timbers. In many of these applications, the natural fiber-thermoplastic composites are placed in an “urban wild land interface,” which is an area where buildings are located in or adjacent to wild lands.

During their service lives, the articles can be exposed to brush and other ground fires generated in the wild lands. Since the thermoplastics and natural fibers used in these composites are inherently flammable, many state and local building code and fire marshal organizations are considering or have established regulations specifying the use of flame-resistant building materials in exterior applications in the urban wild land interface. For example, the California state fire marshal has instituted Urban Wildland Interface Building Test Standards 12-7A-5 which describes the performance requirements of decking and other horizontal ancillary structures in close proximity to primary structures when exposed to direct flames and brands.

Manufacturers of natural fiber-thermoplastic composites are now faced with the need to make their products flame resistant in order for the products to be acceptable for use in the urban wild land interface. Flame resistance can be achieved by adding commercially available flame retardant additives such as Aluminum Trihydrate (ATH), magnesium hydroxide, halogen-based compounds with a number of synergists and char formers, and phosphorus-based compounds and synergists and char formers.

Flame retardants are added to polymer resins to reduce their flammability. Such additives can adversely affect the polymer and interfere with the bonding to fillers within the polymer matrix. These undesirable events are caused by voids and domains of uncompatibilized filler or flame retardant/synergist/char formers or other deleterious effects to the polymer properties or by adversely affecting the processing steps of forming the final polymer composition.

The industry lacks a compatibilized and flame-retardant wood polymer composite in resins, including polyolefins, alloys, and blends with other polymers, as well as impact modifiers, that provide desirable thermal stability for processing, efficiency of flame retardancy and char forming, and reduced adverse effects on the final polymer or its processing steps.

### SUMMARY OF THE INVENTION

The invention relates to flame retardant systems including the brominated flame retardants and chlorinated flame retardants with synergists and char formers for use in cellulose fiber-filled resins in combination with compatibilizers to enhance physical properties and to increase water extraction resistance and long term durability. Desirable embodiments of the invention relate to brominated and chlorinated flame retardant additives, synergists, and char formers for use in resins, including polyolefins, fillers, wood-filled polyolefins, in combination with compatibilizers and methods of making and using the flame retardants and fillers.

The preferred embodiment of the invention includes a wood-plastic composite composition comprising a natural fiber, a thermoplastic olefinic polymer or copolymer; a coupling agent; one or more flame retardants; and one or more synergists. Another embodiment of the current invention further comprises a char former in the wood-plastic composition.

### DETAILED DESCRIPTION OF THE PREFERRED EMBODIMENTS

The current invention comprises a cellulose fiber-plastic composite composition comprising a natural fiber; a thermoplastic olefinic polymer or copolymer; a coupling agent; one or more flame retardants; and one or more synergists. Another embodiment of the current invention further comprises a char former in the wood-plastic composite composition.

Preferably, the current invention comprises one or more brominated or chlorinated flame retardant, one or more synergists, and one or more char formers in combination with a coupling agent to achieve unexpected flame retardancy, physical properties, and long term durability in polyolefin-based wood polymer composites.

The example below describes the invention in an embodiment using wood-filled polypropylene with a maleic anhydride functionalized polypropylene coupling agent and a decabromophenylethane/antimony oxide flame retardant combination. However, the invention also includes other natural fiber-thermoplastic composites using other coupling agents and flame retardants.

Preferred thermoplastics for use in the current invention include a member selected from the group consisting of high-density polyethylene (HDPE), low-density polyethylene (LDPE), linear low-density polyethylene (LLDPE), copolymers of ethylene and propylene, SAN, Polystyrene, ABS, EVA, polyamides, and combinations thereof.

Natural cellulose fibers for use in the current invention include a member selected from the group consisting of “virgin” or recycled wood fiber, hemp, flax, kenaf, rice hulls, bamboo, banana leaves, nut shells, recycled fibers, including fibers from newspaper and boxes, and combinations thereof.

Compatibilizers or coupling agents for use with the current invention include maleic anhydride functionalized high-density polyethylene (HDPE), maleic anhydride functionalize low-density polyethylene (LDPE), maleic anhydride functionalized ethylene-propylene (EP) copolymers, acrylic acid functionalized polypropylene (PP), high-density polyethylene(HDPE), low-density polyethylene (LDPE), linear low density polyethylene (LLDPE), ethylene-propylene (EP) copolymers, styrene/maleic anhydride copolymers, and vinyl trialkoxy silanes.

### Flame Retardants

The invention includes flame retardant compounds of the following formulas.
(1) Decabromodiphenyl oxide sold under the trade name DE-83R

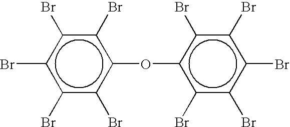

(2) Bis(tribromophenoxy)ethane sold under the trade name FF-680

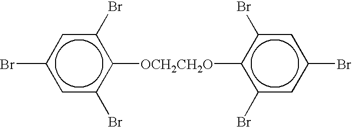

(3) Tetrabromobisphenol A bis(2,3-dibromopropyl ether) sold under the trade name PE-68

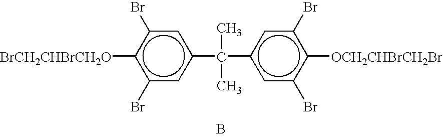

(4) Phenoxy-terminated carbonate oligomer of Tetrabromobisphenol A sold under the trade name BC-52

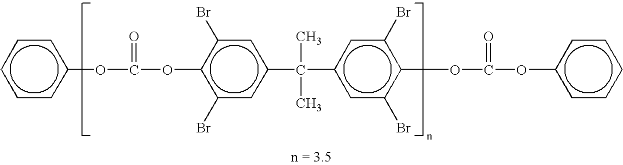

(5) Decabromodiphenylethane

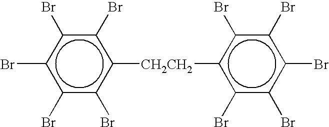

(6) Tetradecabromodiphenoxybenzene

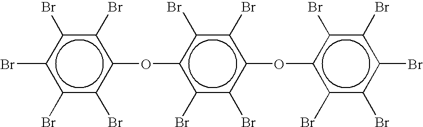

(7) Ethylenebistetrabromophthalimide

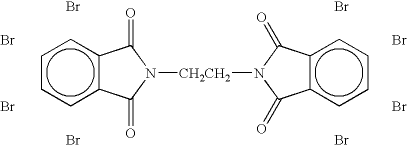

(8) Brominated trimethyl indane

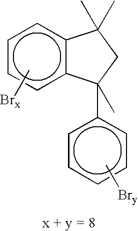

(9) 2,4,6-Tris(2,4,6-tribromophenoxy)-[1,3,5]-triazine

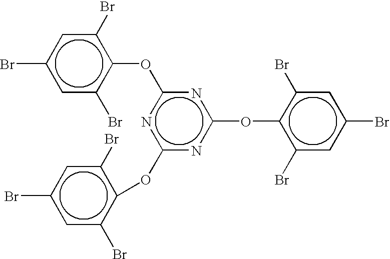

(10) Poly pentabromobenzyl acrylate

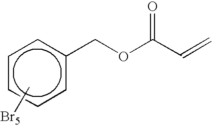

(11) Brominated epoxy oligomer of tetrabromobis phenol A

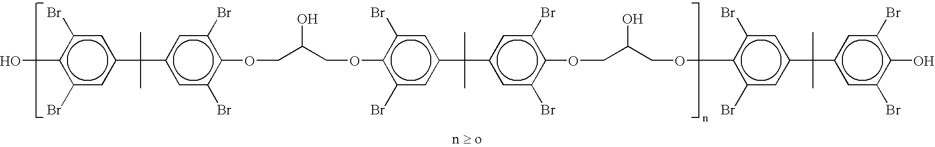

(12) Brominated polystyrene

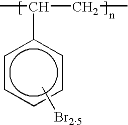

(13) Tris(tribromoneopentyl)phosphate

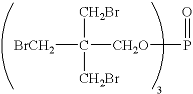

(14) 1,2,3,4,7,8,9,10,13,13,14,14-dodecachloro-1,4,4a,5,6,6a,7,10,10a,11,12,12a-dodecahydro-1,4,7,10-dimethanodibenzo(a,e)cyclooctene

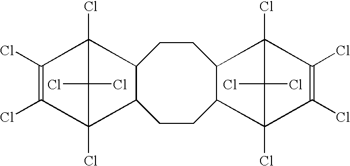

(15) Tetrabromobisphenol S bis(2,3-dibromopropyl ether)

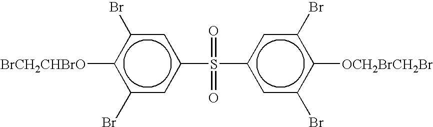

(16) Ethylenebisdibromonorbomanedicarboximide

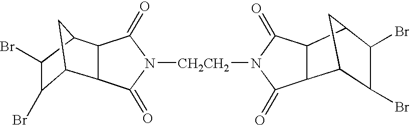

(17) Poly-dibromophenylene oxide sold under the trade name PO-64P

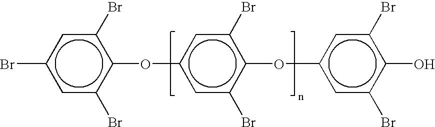

(18) Polydibromostyrene sold under the trade name PDBS-80

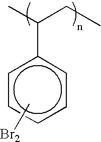

(19) Tetrabromobisphenol sold under the trade name BA-59P

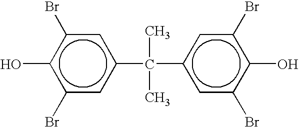

(20) Tetrabromophthalate ester sold under the trade name DP-45

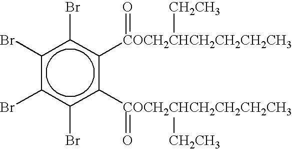

Halogen-free flame retardants include ammonium polyphosphate, phosphonate and phosphinate salts; phosphate esters of alkyl and aryl; bis phosphates being either monomeric or polymeric; melamine cyanurate; bis-melaminepentate; pentaerythritol phosphate; and char forming synergists such as phenolic resins, melamine, melamine phosphates, melamine pyrophosphates, tris 2 hydroxy ethyl isocyanurate, 1,4-Bis(5,5-dimethyl-1,3-dioxacyclophosphorimide)benzene, aerythritols such as dipentaerythritol, polyurea, polyhedral oligomeric silsequioxane, polysiloxane, can also be used with the invention using a compatibilization system to enhance physical properties and long term durability of the wood-polymer composites.

Desirable formulations of flame retardants contain between 1% and 40% alone or in blends of flame retardants in combination with between 1% and 20% of synergists or blends of synergists. The formulation can optionally include 1% to 30% of one or a blend of char formers. The preferred concentration is from 10% to 35% of one or a combination of flame retardants in combination with 3% to 15% of synergists or blends of synergists with or without 5% to 25% of one or a blend of char formers.

The most preferred concentrations are from 20% to 30% of one or a combination of flame retardants in combination with 5% to 12% of synergists or blends of synergists yielding between two and three parts of halogen (bromine or chlorine) to one part of antimony in the case of an antimony-based synergist. Where a char former is required, the preferred concentration is between 7% to 20% alone or in blends.

The coupling agent concentrations are desirably in a concentration range of 0.1% to 10% of the weight of the overall formulation. Preferably the coupling agents cited herein are in a concentration of 0.25% to 5% of the weight of the overall formulation.

Synergists for use in the current invention include antimony trioxide, sodium antimonate, zinc sulfide, zinc stannate, zinc hydroxy stannate, zinc oxide, and combinations thereof.

Char formers for use in the current invention include zinc borate, magnesium hydroxide, silicones, polysiloxanes, melamine, melamine phosphate, melamine pyrophosphates, urea, polyurea, phenolic resins, and combinations thereof.

The invention includes a method for providing a fire-retardant, cellulose fiber-plastic composition. The method involves mixing a cellulose fiber with a thermoplastic at a temperature and pressure sufficient to bond said fiber and said thermoplastic. The next step is incorporating an effective concentration of at least one flame retardant, at least one coupling agent, and at least one synergist. The mixture then undergoes molding and cooling the composition into a preform.

### EXAMPLES

Table 1 lists the materials used in these examples. The 4020 wood flour is a 40 mesh soft wood fiber typically used in wood-filled PP composites. The HB9200 is a 4 MFR polypropylene homopolymer made by Innovene. Polybond 3200 from Chemtura Corporation is a functionalized polypropylene containing 1% by weight of maleic anhydride and having a MFR of 110 gm per 10 minutes at 190° C. and 2.16 kg. Firemaster 2100 (decabromophenylethane) and antimony trioxide are also products of Chemtura Corporation. Naugard B-25 is a blend of phenolic and phosphate antioxidants from Chemtura and was added to prevent degradation during processing and subsequent testing.

Duplicate samples of each of the formulations were mixed by preblending the powder ingredients in 60 to 70 gram batches and then mixing in a Brabender internal mixer for approximately 15 minutes at a mixer temperature of 190° C. Plaques (5″ long×4½″ wide×⅛″ thick) were then compression molded at 190° C. for three minutes under 40M lbs force in a Tetrahedron automated compression molding press. After conditioning for 16 hours in a dry environment, the samples were tested for flexural properties (ASTM D-790), specific gravity (ASTM D-792), water uptake after 24 hours of immersion in deionized water, and flammability (UL-94).

Results

| | Comparative | Comparative | Invention |
|---|---|---|---|
| | Example A | Example B | Example 1 |
| 4020 Wood Flour | 55 | 26 | 26 |
| Naugard B-25 | 0.1 | 0.1 | 0.1 |
| Polybond 3200 | | | 3 |
| Firemaster 2100 | | | 22 |
| Antimony Trioxide | | | 7 |
| HB9200 PP | 44.9 | 73.9 | 41.9 |
| Specific Gravity | 1.10 | 0.98 | 1.30 |

Flexural Properties - ½″ wide samples tested at
Crosshead spd of 0.05″/min

| | | | |
|---|---|---|---|
| Modulus, MPa | 2,677 | 2,305 | 3,136 |
| * Change vs. Comparative | 0% | 14% | 17% |
| Example A | | | |
| Strength, MPa | 27.6 | 42.4 | 40.4 |
| * Change vs. Comparative | 0% | 54% | 46% |
| Example A | | | |

Water Uptake - 30 da immersion @ RT

| | | | |
|---|---|---|---|
| Weight Gain, % | 14.7 | 2.4 | 6.0 |

Flammability Test

| | | | |
|---|---|---|---|
| UL-94 @ ⅛″ Thickness | Fail | Fail | V-1 |

These data clearly demonstrate that the addition of both a coupling agent and a flame retardant resulted in improved flexural modulus and strength plus better flame retardancy.

We claim:

1. A flame-retardant wood-plastic composition comprising:
a cellulose fiber;
a thermoplastic polymeric material;
from 0.1 wt % to 10 wt % of a coupling agent;
from 1 wt % to 40 wt % of a flame retardant; and
from 1 wt % to 20 wt % of a synergist.

2. The composition of claim 1 further comprising from between 1 wt % to 30 wt % of a char former.

3. The composition of claim 1 wherein;
said coupling agent is from 0.25 wt % to 5 wt %;
said flame retardant is from 10 wt % to 35 wt %; and
said synergist is from 3 wt % to 15 wt %.

4. The composition of claim 3 further comprising a char former in a concentration from 5 wt % to 25 wt %.

5. The composition of claim 3 wherein;
said coupling agent is from 0.5 wt % to 2 wt %;
said flame retardant is from 20 wt % to 30 wt %; and
said synergist is from 5 wt % to 12 wt %.

6. The composition of claim 5 further comprising a char former in a concentration from 7 wt % to 20 wt %.

7. The composition of claim 1 wherein said cellulose fiber is a member selected from the group consisting of “virgin” wood flour, recycled wood flour, wood fiber, hemp, flax, kenaf, rice hulls, bamboo, nut shells, and combinations thereof.

8. The composition of claim 5 wherein the flame retardant is a member selected from the group consisting of:
decabromodiphenyl oxide, bis(tribromophenoxy)ethane,
tetrabromobisphenol A bis(2,3-dibromopropyl ether),
phenoxy-terminated carbonate oligomer of tetrabromobixphenol A,
tetradecabromodiphenoxybenzene,
ethylenebixtetrabromophthalimide,
brominated trimethyl indane,
2,4,6-tris(2,4,6-tribromophenoxy)-p1,3,5]-triazine, poly pentabromobenzyl acrylate,
brominated epoxy oligomer of tetrabromobis phenol A,
brominated polystyrene,
tris(tribromoneopentyl)phosphate,
1,2,3,4,7,8,9,10,13,13,14,14-dodecachloro-1,4,4a,5,6,6a,7,10,10a,11,12,12a-dodecahydro-1,4,7,10-dimethanodibenzo(a,e)cyclooctene,
tetrabromobisphenol S bis(2,3-dibromopropyl ether),
ethylenebisdibromonorbomanedicarboximide,
poly-dibromophenylene oxide,
polydibromostyrene, tetrabromobisphenol A,
tetrabromophthalate ester, and combinations thereof.

9. The composition of claim 8 wherein said coupling agent is a member selected from the group consisting of maleic anhydride functionalized HDPE, maleic anhydride functionalize LDPE, maleic anhydride functionalized EP copolymers, acrylic acid functionalized PP, HDPE, LDPE, LLDPE, and EP copolymers, styrene/maleic anhydride copolymers, vinyl trialkoxy silanes, and combinations thereof.

10. The composition of claim 9 wherein said synergist is a member selected from the group consisting of antimony trioxide, sodium antimonate, zinc sulfide, zinc stannate, zinc hydroxy stannate, zinc oxide, and combinations thereof.

11. The composition of claim 2 wherein said char former is a member selected from the group consisting of zinc borate, magnesium hydroxide, silicones, polysiloxanes, melamine, melamine phosphate, melamine pyrophosphates, urea, polyurea, phenolic resins, and combinations thereof.

12. A flame-retardant wood-plastic composition comprising:
a cellulose fiber, said cellulose fiber is a member selected from the group consisting of “virgin” wood flour, recycled wood flour, wood fiber, hemp, flax, kenaf, rice hulls, bamboo, nut shells, and combinations thereof
a thermoplastic polymeric material;
from 0.1 wt % to 10 wt % of a coupling agent;
from 1 wt % to 40 wt % of a flame retardant, the flame retardant is a member selected from the group consisting of:
decabromodiphenyl oxide, bis(tribromophenoxy)ethane,
tetrabromobisphenol A bis(2,3-dibromopropyl ether),
phenoxy-terminated carbonate oligomer of tetrabromobixphenol A,
tetradecabromodiphenoxybenzene,
ethylenebixtetrabromophthalimide,
brominated trimethyl indane,
2,4,6-tris(2,4,6-tribromophenoxy)-p1,3,5]-triazine, poly pentabromobenzyl acrylate,
brominated epoxy oligomer of tetrabromobis phenol A,
brominated polystyrene,
tris(tribromoneopentyl)phosphate,
1,2,3,4,7,8,9,10,13,13,14,14-dodecachloro-1,4,4a,5,6,6a,7,10,10a,11,12,12a-dodecahydro-1,4,7,10-dimethanodibenzo(a,e)cyclooctene,
tetrabromobisphenol S bis(2,3-dibromopropyl ether),
ethylenebisdibromonorbomanedicarboximide,
poly-dibromophenylene oxide,
polydibromostyrene, tetrabromobisphenol A,
tetrabromophthalate ester, and combinations thereof, and
from 1 wt % to 20 wt % of a synergist, said synergist is a member selected from the group consisting of antimony trioxide, sodium antimonate, zinc sulfide, zinc stannate, zinc hydroxy stannate, zinc oxide, and combinations thereof.

13. A method of use for providing a fire-retardant, cellulose fiber-plastic composition comprising:
mixing a cellulose fiber with a thermoplastic at a temperature and pressure sufficient to bond said fiber and said thermoplastic;
incorporating an effective concentration of at least one flame retardant, at least one coupling agent, and at least one synergist;
molding and cooling said composition into a preform.
